(19) United States
(12) Patent Application Publication
(10) Pub. No.: US 2017/0108277 A1
(43) Pub. Date: Apr. 20, 2017

(54) Air-Cooled Heat Exchange System

(71) Applicant: RBC Green Energy II, LLC, Montecito, CA (US)

(72) Inventors: Peter Platell, Stockholm (SE); Ove Platell, Sigtuna (SE); Roland Fjallstrom, Sautee, GA (US)

(21) Appl. No.: 15/314,477

(22) PCT Filed: May 28, 2015
(86) PCT No.: PCT/US15/33029

§ 371 Date: Nov. 28, 2016

Related U.S. Application Data
(60) Provisional application No. 62/004,073, filed on May 28, 2014.

(51) Int. Cl. F28D 1/03; B60K 11/08

(52) U.S. Cl. CPC F28D 1/03; B60K 11/08

(57) ABSTRACT

An air-cooled heat exchange system with channels containing a coolant, which system includes a row of rectangular heat exchange elements, which are connected edge to edge angled to and fro and contain the channels with the coolant. The row of heat exchange elements is arranged in a low, wide and long housing with open ends, which is arranged to be flown through by a cooling air flow. The row of heat exchange elements extends, partly crosswise the flow direction of the cooling air flow between two low side walls attached to the side walls and to the roof and bottom, partly in the longitudinal direction of the housing mainly a distance between the inlet and outlet openings, which distance is essentially longer than the height of the housing and the open ends.

### CROSS-REFERENCE TO RELATED APPLICATIONS

This application claims the benefit of U.S. Provisional Application No. 62/004,073 filed 28 May 2014 the entire contents and substance of which is hereby incorporated by reference.

### BACKGROUND OF THE INVENTION

1. Field of the Invention

The present invention relates generally to heat exchange systems, and more specifically to an air-cooled heat exchange system with channels containing a coolant and connected by pipes to cooling ducts of an object to be cooled.

2. Description of Related Art

Conventional motor vehicle air-cooled heat exchange systems include cooling systems of the engine and a comfort device include an essentially square, vertical heat exchanger element and one or a pair of propeller (axial) fans closely arranged one after the other and located in front of the engine. The moving vehicle creates wind that chills the cooler, and if necessary, additional cooling can be supplied by the fan or fans. The fan(s) can be surrounded by a ring-shaped housing to amplify the fan(s) cooling capacity.

In these convention systems, cooling effectiveness is limited in large extent by space considerations. The engine compartment is dominated by the engine and associated components; thus, there is a limited space available for distributing cooling air having left the cooler and fans resulting in suboptimal cooling capacity.

Stationary heat exchange systems suffer similar disadvantages. For example, DE 2450093 discloses a folding of a conventional square cooler by dividing it in several disc-shaped heat exchange elements, which are connected edge-to-edge and angled about. Since the space in the same direction as the flow direction of the cooling air is limited, the increase of the total area of the heat exchange elements is limited, and no wide field application of this technology was adopted.

DE 2747785 discloses placing a conventional cooling device with two oblique heat exchange elements and an axial fan on the roof of a commercial vehicle. SE 437131 discloses a cooling device with a vertical cooler and a fan on the roof of a truck. Yes, the cooling capacity of both of these prior art cooling devices is extremely limited in relation to the space that is available. Further, the disclosed housings present a considerable fall in the wind pressure from inlet to outlet with or without fan support, and therefore are not adequate solutions to the current demand of more efficient cooling systems required by society's increased use of, for example, larger comfort devices, engine inter-coolers, and vehicles operating in areas with very hot climate. EP 0097287 is yet another example of a disadvantageous solution, wherein the cooling device has an axial fan and two cooling elements one after the other in a tubular housing.

To overcome these conventional operability and efficiency issues, an air-cooled heat exchange system is herein presented, the system including channels containing a coolant and connected to cooling ducts of an object to be cooled, e.g. an internal combustion engine, which system comprises a row of rectangular disc-shaped, air pervious heat exchange elements, which are connected edge to edge, angled to and fro a specific angle between the heat exchange elements with the channels containing the coolant is highly desirable. It is the intention of the present invention to provide for such an industrial need.

### BRIEF SUMMARY OF THE INVENTION

Briefly described, in a preferred form, the present invention comprises a thermal management system with considerably improved cooling capacity over the current state of the art based on optimal utilization of accessible space and use of heat exchange elements in a novel and non-obvious way, which result in advantages to mobile as well as stationary thermal management systems.

The present thermal management system incorporating the inventive heat exchange technology finds primary use with internal combustion engine mantel water cooling. The present technology also has applications within the aerospace industry. One advantageous benefit provided by the present invention is a significantly reduced parasitic load, i.e. fan power, for cooling of the radiator than currently available.

On low RAM pressure applications such as city buses, construction, mining, forestry and construction machinery, the parasitic load due to the novel design having a much lower pressure drop on the airside is about 90% lower than conventional technology at the same heat dissipation in kW/m²K. This can equate to fuel efficiency improvements of more than 15% based on shaft power.

In an exemplary embodiment, the present invention is a thermal management system for an object to be cooled, the system comprising a housing with heat exchange media located therein, the heat exchange media comprising a V-shaped structure of heat exchange elements mounted vertical between the top and the bottom of the housing.

The housing can have an average length greater than its average height. The housing can include an inlet, and outlet, the bottom, the top, and opposing side walls.

The heat exchange elements can be rectangular, disc-shaped, and air pervious.

The system can further comprise a coolant pump to provide coolant to the heat exchange media.

The system can further comprise a flow diverter, a flow aperture, and an outer channel, wherein the flow diverter diverts the flow of air exiting the outlet of the housing through the flow aperture and into the outer channel.

The system can further comprise a fan assembly.

The present invention can comprise various elements (or portions of elements) in two main forms, a passive system that is generally stationary or otherwise designed to remain fixed, and an active system that is intended to move relatively to the passive system. In preferred form, the passive system comprises a majority portion of the housing and the heat exchange media, while the rear portion of the housing, including the ultimate exhaust of air through the system, is inclusive in the active system, such that the direction of the exiting air can be changed and/or boosted with a fan assembly.

In another exemplary embodiment, the present invention comprises an air-cooled heat exchange system comprising a passive cooling system comprising a housing having an average length greater than its average height and heat exchange media located within the housing, wherein the housing includes an inlet, and outlet, a bottom, a roof, opposing side walls, wherein the heat exchange media comprises a plurality of heat exchange elements extending across the width of the housing, from one side of the housing to the other side of the housing, adjacent heat exchange elements connected to one another at an end portion, the plurality of heat exchange elements located at an angle from one another across the width of the housing, wherein the heat exchange elements are rectangular, disc-shaped, and air pervious, and wherein the housing accepts moving air through the inlet, through the heat exchange media arranged at least partially crosswise to the flow of air through the inlet, and the air exiting the housing through the outlet.

In a preferred embodiment, the housing is generally rectangular, with a uniform height, width and length along its coordinates, but it need not be so designed. The bottom or roof of the housing can contain arcuate portions and otherwise not lie in parallel planes. The sides of the housing can similarly contain arcuate portions and otherwise not lie in parallel planes. The square area presented by the inlet and outlet of the housing need not be equal.

The air-cooled heat exchange system can further comprise an active cooling system in proximity to (or be a part of) the outlet of the housing, the active cooling system providing directional control of the air exiting the air-cooled heat exchange system that can be in an exiting direction different from the direction of air through the inlet of the housing.

The active cooling system can comprises a flow diverter, a flow aperture, and an outer channel, wherein the flow diverter diverts the flow of air exiting the outlet of the passive cooling system through the flow aperture and into the outer channel.

The active cooling system can further comprise a fan assembly.

In another exemplary embodiment, the present invention comprises an air-cooled heat exchange system comprising channels containing a coolant and connected to cooling ducts of an object to be cooled, e.g. an internal combustion engine, which system comprises a row of rectangular, disc-shaped, air pervious, heat exchange elements that are connected edge to edge, angled to and fro a specific angle between the heat exchange elements with the channels containing the coolant, wherein the row of heat exchange elements, which is extends partly crosswise the flow direction are arranged in a housing with two open ends forming a mainly rectangular inlet opening and outlet opening with low height, where height is defined as the shortest side of inlet and outlet rectangular and extension in the air flow direction between the inlet and outlet rectangular that is considerably longer/larger than the height.

In another exemplary embodiment, the present invention comprises an air-cooled heat exchange system with channels containing a coolant and connected by pipes to cooling ducts of an object to be cooled, the system comprising a row of rectangular, disc-shaped, air pervious, heat exchange elements that are connected edge to edge, angled to and fro a specific angle between the heat exchange elements with the channels containing the coolant, wherein the row of heat exchange elements is arranged in a low, wide and long housing with two open ends forming a mainly rectangular inlet opening and outlet opening for a cooling air flow arranged to pass through the row of heat exchanging elements, which extends, partly crosswise to the flow direction of the cooling air flow between two low, opposite sides of the housing, attached to the sides and to remaining two opposite sides, a bottom and a roof of the housing, partly in the longitudinal direction of the housing mainly a distance between the inlet and the outlet openings, which distance is longer than the height of the inlet and the outlet openings.

The housing can be mounted on or in a vehicle with the inlet opening exposed to a speed related wind at movement of the vehicle. The vehicle can be a motor vehicle, preferably a bus, with a rear-mounted engine.

If so mounted, a fan device of a cross-flow type can be provided for creating a cooling air flow in an absence of the requisite speed related wind.

A short inlet channel from the inlet opening and/or a short outlet channel to the outlet opening can be arranged to communicate with an outer channel attached to the housing, which channel has a width equal to the width of the inlet opening or the outlet opening, respectively.

A fan device of cross-flow type having an extension corresponding to the width of the inlet opening or outlet opening, as the case may be, can be positioned upstream and/or downstream, respectively, the heat exchange elements for creating a cooling air flow.

The object to be cooled can be positioned in a suitably matched container having an upper side supporting the housing in the horizontal position, in addition to which a fan device of cross-flow type having an extent corresponding mainly to the complete inlet opening or outlet opening, respectively, can be positioned upstream and/or downstream the heat exchange elements for creating a cooling air flow.

The inlet and outlet openings of the housing can be positioned in proximity to and in parallel to two opposite edges of the upper sides of the container, wherein at least end of the housing can be extended with a silencing shield, which is gently curved around and distal the corresponding edge and down along the side of the container distal the side for allowing cooling air to pass.

The silencing shield can be provided with horizontal, air pervious slots with guide rails for guiding the air flow through the slots with diffuser action.

The inlet channel and/or outlet channel can communicate with the outer channel through an opening with a valve flap, which in open position is arranged to close the connection between the inlet opening or outlet opening, as the case may be, and the inlet channel or outlet channel, upstream or downstream, respectively, of the opening.

The outer channel can contain the fan device and be supported by the housing via pivot or otherwise displaceable to being moved to an airtight connection to the inlet opening or outlet opening.

The housing can be mounted in a horizontal position on the roof of a vehicle with the outer channel directed obliquely downwards at a fore or aft roof edge.

The housing can mounted in a vertical position at a side of a vehicle completely or partly integrated with the side of the vehicle body and with the outer channel positioned in the interior of the vehicle when in is in a non-activated position.

The coolant filled channels of the heat exchange elements can extend perpendicular to the roof and bottom of the housing and have each two external, axial vanes for optimal heat exchange with cooling air flowing by in spaces between adjacent ribs, which spaces are arranged to guide the cooling air obliquely through the heat exchange elements in a longitudinal direction of the housing for attaining a minimal fall of pressure.

The axial ribs can be compressed parts of the channels.

In another exemplary embodiment, present invention provides heat exchange elements arranged in a low, wide and long housing with two open ends forming a mainly rectangular inlet opening and outlet opening for a cooling air flow arranged to pass through the row of heat exchange elements, which extends, partly crosswise the flow direction of the cooling air flow between two low, opposite sides of the housing, attached to the sides and to remaining two opposite sides, i.e., a bottom and roof of the housing, partly in the longitudinal direction of the housing mainly a distance between the inlet and the outlet openings, which distance is essentially longer than the height of the inlet and the outlet openings. The heat exchange elements fill up a low, wide and especially long housing and the cooling air is passing through the heat exchange elements only once, dispersed on a very large heat exchanger element area. By comparison with conventional heat exchangers having the same heat transfer performance, the device according to the invention obviously proves a considerably lower fall of pressure, which is especially important with devices having such long operating times as the case in question here.

The heat exchanger device according to the invention constitutes a complete unit with a special shape which at application to a vehicle, e.g. a motor vehicle, makes it suited for being placed on the roof of a vehicle or inside the vehicle, e.g. along the underside of a hood (engine bonnet), with the inlet opening exposed to the wind related to the speed of the moving vehicle. In that case it is important for attaining a low drop of pressure that the cooling air can flow from inlet to outlet without any other change of direction than the slight one that occurs at passage of the heat exchange elements. The present invention is particularly well suited for cooling of the engine of a large motor vehicle, preferably a bus or coach, with rear-mounted engine, where it is extremely difficult to achieve a sufficient cooling in a crowded engine compartment, where fire accidents frequently occur. With the housing positioned for example at the very back of the roof of the vehicle the cooling pipes to the engine are short, the cooling extremely good, and no heated flow of cooling air is spread to the engine compartment. All the heated flow of cooling air is instead accessible at the outlet opening and may be used for instance for heating of the inner space of the vehicle.

In order to uphold cooling at absence of requisite speed related wind the heat exchanger device has to be equipped with a fan device, and a number of alternatively usable fan devices, all of cross-flow type, are described in the following description. The expression fan devices of cross-flow type include all types, which suck in air laterally and force it out laterally, right away or with an angular change of e.g. 90 degrees. The fan device is elongated and may fill up a broad and elongated opening, which is the case here, and may comprise one or more axially connected fan devices of cross-flow type or radial or tangential fan devices, as they sometimes are called, or a corresponding row of small fan devices of propeller type. A preferred embodiment of the invention is provided with a short inlet channel from the inlet opening and/or a short outlet channel to the outlet opening arranged to communicate with an outer channel attached to the housing, which channel has a width equal to the width of the inlet opening or outlet opening, respectively, and contains a fan device of cross-flow type to be activated for creating a cooling air flow at absence of a requisite speed related wind. It is possible, however, if a certain disturbance of the influence of the speed related wind on the heat exchange is acceptable, to arrange, as an alternative and for the sake of simplicity, a permanently arranged fan device of cross-flow type with an extension corresponding to all the width of the inlet opening before the heat exchange elements and/or of all the width of the outlet opening after the heat exchange elements.

The system according to the invention provided with a fan assembly is moreover specially suited as a stationary heat exchanger device for cooling of a cooling object, e.g. an internal combustion engine, built-in in a container. All the upper side of the container is with advantage utilized for the heat exchange, i.e. the housing of the device covers all the upper side with the inlet opening and the outlet opening preferably positioned along the longest side edges. A fan device of cross-flow type and with an extension corresponding to mainly all the inlet opening or outlet opening is located before and/or after the heat exchange elements for producing a cooling air flow. The device according to the invention shows its superiority also here to a conventional heat exchanger device with the same heat exchange capacity and using a propeller fan and one or more vertical heat exchange elements, wherein the device according to the invention has an essentially lower drop of pressure when the cooling air flow passes through the heat exchange elements. Inlet and outlet of cooling air to and from the stationary heat exchanger device should not exist directly through the inlet and outlet openings with respect to disturbing loud and draught to the environment. Hence, an efficient sound damper and diffuser are necessary. Such objects are unwieldy and space consuming, but may preferably be realized here by arranging the inlet and outlet openings of the housing in proximity to and in parallel with two opposite edges of the upper side of the container, where at least one end of the housing is extended with a silencing shield, which is gently curved around and distal the corresponding edge and down along the side of the container distal the side for allowing cooling air to pass. An efficient silencing and diffuser action is obtained by providing the silencer shield with horizontal, air pervious slots with guide rails for guiding the air flow through the slots with diffuser action.

### BRIEF DESCRIPTION OF THE DRAWINGS

Various features and advantages of the present invention may be more readily understood with reference to the following detailed description taken in conjunction with the accompanying drawing sheets.

FIG. 1 is a plan view of a first exemplary embodiment of the present invention with a housing having its upper half omitted in order to show the position of the heat exchange elements.

FIGS. 2a and 2b are side views of the embodiment shown in FIG. 1, partly in section, showing the working position of the fan device and the speed related wind.

FIGS. 3a and 3b are side views of a second exemplary embodiment of the present invention showing the working position for utilizing the speed related wind and the fan device.

FIGS. 4a and 4b are side views of a third exemplary embodiment of the present invention showing the working position for utilizing the speed related wind and the fan device.

FIG. 5 is a side view of a bus with a heat exchanger device according to an exemplary embodiment of the present invention positioned on the very back of the roof.

FIG. 6 is a side view of a truck with a heat exchanger device according to an exemplary embodiment of the present invention positioned on the front part of the roof.

FIG. 7a is a side view of a truck with a heat exchanger device according to an exemplary embodiment of the present invention positioned on the roof.

FIG. 7b is a plan view along the line VIII-VIII in FIG. 7a.

FIG. 8a is a side view of a van with a heat exchanger device according to an exemplary embodiment of the present invention located in a vertical position inside a slight bulging of one side of the van.

FIG. 8b is a plan view of the van shown in FIG. 8a.

FIG. 9a is a perspective view of a container with a heat exchanger device according to an exemplary embodiment of the present invention.

FIG. 9b is a perspective view of a container with a conventional heat exchanger device (prior art).

FIG. 10 is a perspective view, with the nearest end wall omitted, of a container with the heat exchanger according to an exemplary embodiment of the present invention provided with a diffuser and a silencer device.

FIG. 11 is a perspective view of a fan device of cross-flow type with propeller fans.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

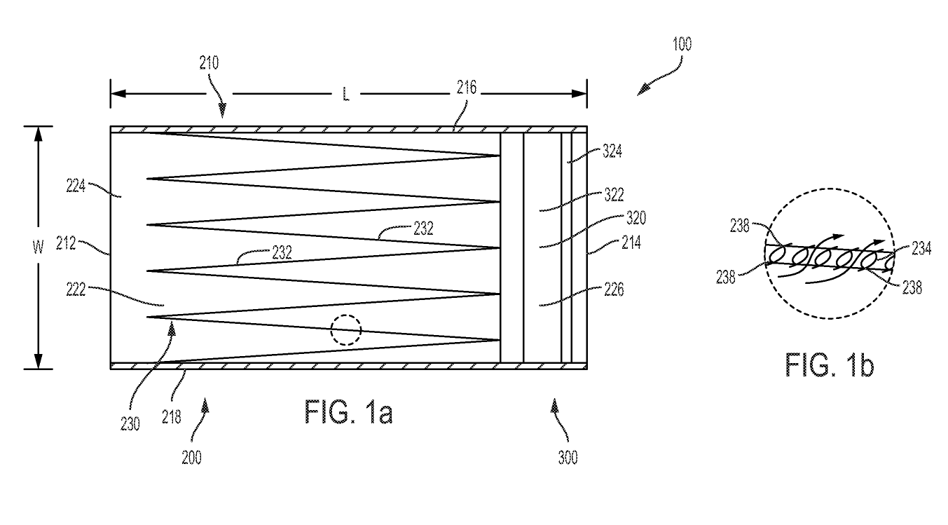

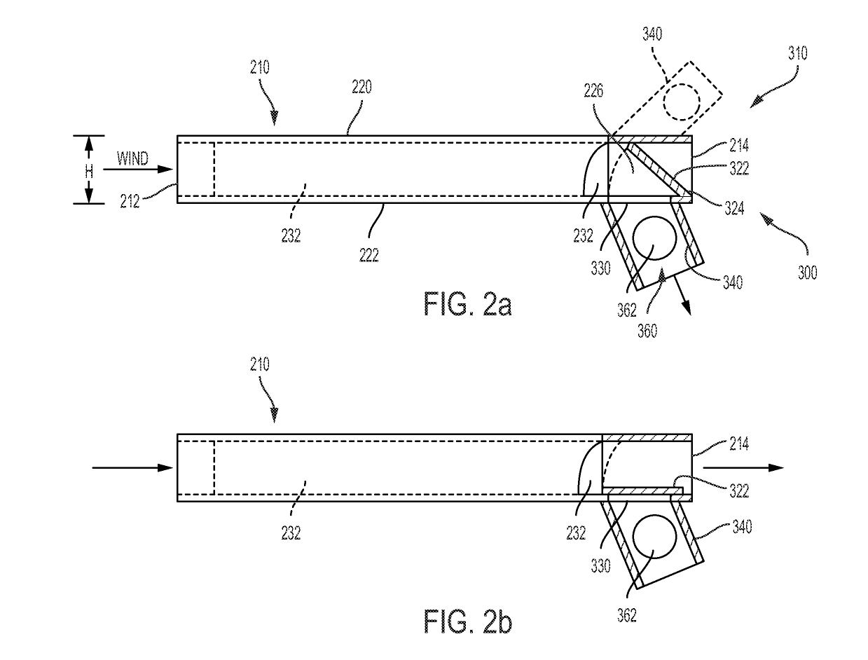

In an exemplary embodiment of the present invention, FIG. 1 and FIGS. 2a and 2b show a preferred embodiment of the present air-cooled heat exchange system 100 comprising a passive cooling system 200 and an active cooling system 300. The passive cooling system 200 generally includes stationary elements of the present invention 100, wherein the active cooling system 300 includes moveable elements of the present invention 100. In an exemplary embodiment, the passive cooling system 200 is located in the front of the system 100, and the active cooling system 300 located in the back. It will be understood by those of skill in the art that other arrangements are possible, where the objects of the present invention are met with passive and active systems located in different arrangements.

The passive cooling system 200 comprises a housing 210 and heat exchange media 230. The housing 210 comprises an inlet 212, an outlet 214, first side wall 216, second side wall 218, a roof 220 and a bottom 222, and contains the heat exchange media 230 therein. Generally, the housing 210 is provided with a relatively large width W, a relatively large length L, and a relatively small height H in order to present relatively low air resistance in mobile applications while also presenting a configuration that is as practical as possible in stationary applications.

The front side of the housing 210 has the inlet opening 212 and the backside the outlet 214, the inlet presenting inlet channels 224 and the outlet presenting outlet channels 226, the inlet and outlet being openings for air to travel through the length of the housing 210 and across the heat exchange media 230.

In an exemplary embodiment, the heat exchange media 230 comprises a plurality of heat exchange elements 232 comprising rectangular discs that are connected to one another in a general V-shape from one side wall 216 to the opposite side wall 218 with an upper edge line in contact with the roof 220 of the housing and a bottom edge line in contact with the bottom 222 of the housing. An inlet channel 224 is situated between the inlet opening 212 and the heat exchange elements 232, and an outlet channel 226 is situated between the outlet opening 214 and the heat exchange elements 232.

As shown in FIGS. 1-4, the active cooling system 300 is located in the back of the present invention 100, and can take a variety of forms. As shown in FIGS. 2a-2b, the active cooling system 300 includes a moveable portion 310, capable of a range of movement about the horizontal axis of the housing 210 such that exiting air from the housing 210 can have a variety of vectors of discharge. As shown, the moveable portion 310 can include portions of the housing elements of the passive cooling system 200 (be extensions of the elements), or can include discretely different elements from the passive cooling system 200.

For example, at least a portion of the outlet channel 226 can be a part of the active cooling system 300, or the elements of the active cooling system 300 can be designated with different references to its elements. One of skill in the art will understand how portions of the passive cooling system 200 can also be a part of the active cooling system 300, or in other embodiments, the same features of the active cooling system 300 be provided with references that are not embodied as portions of the passive cooling system 200.

The active cooling system 300 includes the moveable portion 310 that can take many forms in order to perform a similar function—alter the otherwise straight course of air from inlet to outlet, and direct the outlet air in a direction above, below (or the same) as the horizontal axis of the housing 210.

Thus, in one embodiment, the active cooling system 300 comprises a flow diverter 320, a flow aperture 330 and an outer channel 340. As shown in FIGS. 2a-2b, at least a portion of the outlet channel 226 includes the flow aperture 330 that extends between the side walls 216, 218 of the housing and is covered by the flow diverter 320, here a flap valve 322. The flap valve is pivotable on a shaft 324, as shown in FIG. 2a. In its upwards directed position, the end flap 322 exposes the opening 330 to the outer channel 340 that is directed obliquely downwards.

The active cooling system 300 can further comprise a fan assembly 360. As shown in FIGS. 2a-2b, the outer channel 340 encloses the fan assembly 360, shown comprising a fan device 362 of cross-flow type, which extends between the side walls of the channel 340 that can have the same width as the width between the side walls 216, 218 of the housing 210. The flap 322 closes at the same time the connection between the outlet opening 214 and the outlet channel 226 downstream the opening 330, as shown in FIG. 2a. The cross-flow fan device 362 may, with respect to the comparatively large width of the housing 210, comprise more than one cross-flow fan devices connected to each other, for example, on a common shaft.

The housing 210 is mountable on a roof of a vehicle, preferably a motor vehicle, and moved in the left hand direction as shown on the drawing, wherein the WIND arrow is shown directed to the right. When mounted on a moving vehicle, the speed related wind WIND will flow into the housing, through the heat exchange elements 232, and out of the housing along the turned down valve flap 322.

The present invention 100 provides many of its benefits by limiting the air resistance at the passage through the heat exchange elements to be as small as possible, and the heat exchange with the elements 232 as high as possible in proportion to the different design limits of the cross-sectional area of the housing 210. The elements 232 have, as indicated by the amplified detail in FIG. 1b, fluid filled channels 234, which in a usual manner form a part of a flow circuit (not shown). The channels are designed with ribs 238, which are formed by partial compression of the channels 234, and are arranged with small intervals with the ribs oblique in relation to the plane of the elements, such that the air flow, (marked with small arrows), may pass between the channels with the smallest of resistance yet effective heat efficiency.

If the speed of the vehicle is reduced, simply relying on wind cooling alone with no longer be efficient. In that case, the valve flap 322 is automatically folded up by a common, (not shown), device such that the outlet opening 214 is closed and the opening 330 to the outer channel 340 is opened at the same time as the cross-flow fan device 362 is started and sucks air through the elements 232 without permitting air to leak from outside through the outlet opening 214, as shown in FIG. 2a. Actual air flow in the various configurations of the active cooling system 300 are shown by arrows.

In some cases it may be appropriate to direct the outer channel 340 containing the cross-flow fan device obliquely upwards, as shown by dashed lines in FIG. 2a, instead of obliquely downwards, which corresponds to an imaginary turning of the housing 210 180 degrees around its longitudinal axis. Sometimes it may be desirable to let the speed related wind flow in the opposite direction to the direction shown in FIGS. 2a and 2b. In that case, it is necessary to drive the fan device 362 to blow air into the housing 210, when necessary, which is a preferable situation, because it then is cold air that is pressed through the heat exchange elements 232.

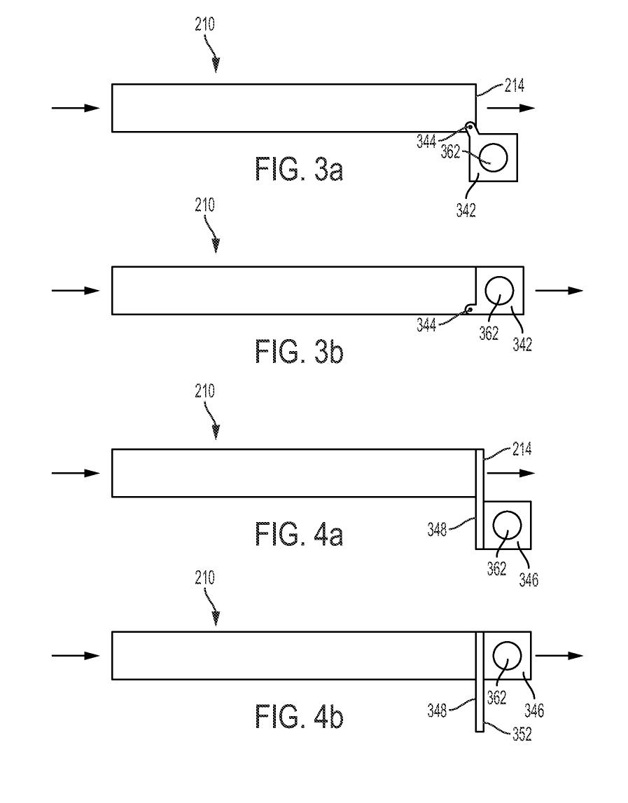

FIGS. 3a and 3b show another exemplary embodiment of the active cooling system 300. The fixed outer channel 340 is replaced by an outer channel 342 that contains the cross-flow fan device 362 and is pivoted by a trunnion 344 attached to an edge of the outer channel and rotatably mounted in the housing 210. When in a folded (rotated) down position, the cross-flow fan device 362 is off and the openings to the channel 342 covered by plates, (not shown), in order to protect the channel from dirtying. In this position, the speed related wind is used for cooling the heat exchange elements in the housing 210.

When the speed related wind becomes insufficient, the plates are withdrawn from the openings of the channel 342 and the channel 342 pivoted up to engagement with the outlet opening 214, as shown in FIG. 3b. At the same time the cross-flow fan device 362 starts for suction of air through the heat exchange elements in the casing 210.

FIGS. 4a and 4b show another exemplary embodiment of the active cooling system 300. The outer channel 340 is replaced by an outer channel 346 that contains the fan device 362 and is journalled displaceable on a guide device 348, which is attached transversely to the housing 210 at the outlet opening 214 and includes a fixed wall 352, which is adapted to protect the inner of the channel 346 from dirtying. With the channel 346 in its lower position the speed related wind will be utilized for cooling the heat exchange elements in the housing 210. When the speed related wind becomes insufficient an operating device, (not shown), moves up the channel 346 up to sealing engagement with the outlet opening 214 of the housing 210.

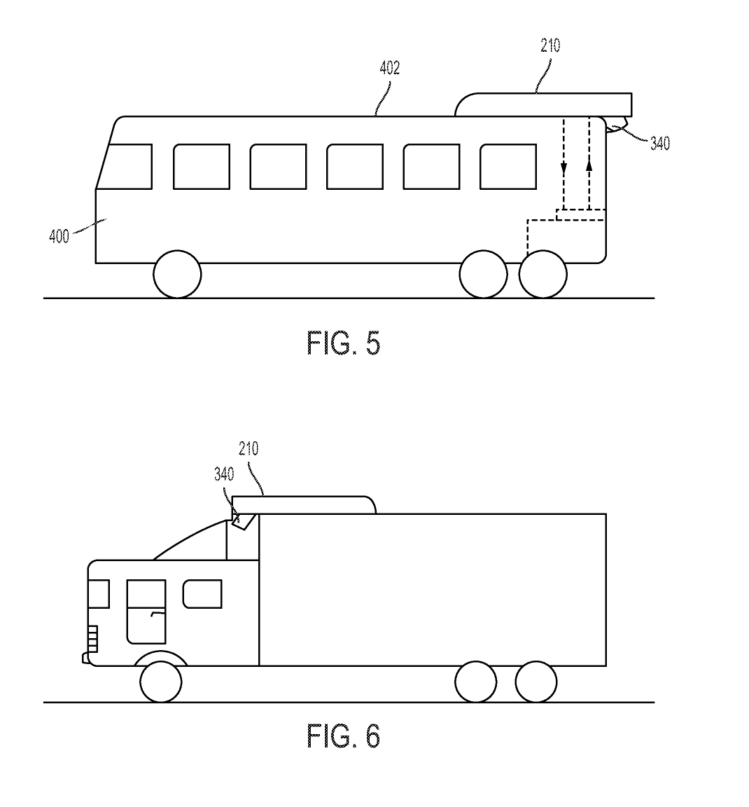

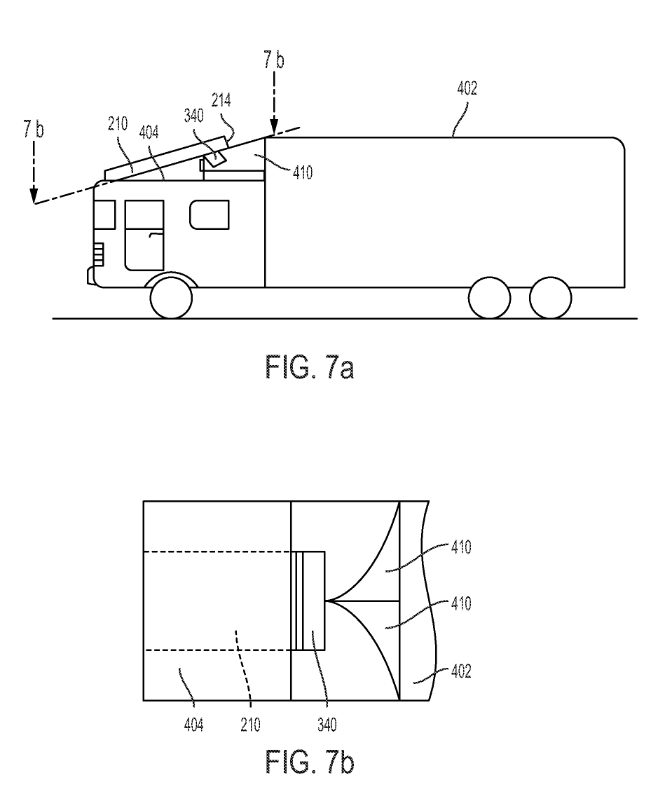

The present invention 100 is capable of being used for all kinds of vehicles, including for example speedboats, but is primarily intended for fluid-cooled motor vehicles with air-condition and/or cooling, or freezing plants. In that respect the housing 210 of the present invention 100 may be positioned at the back of the vehicle roof 402, as shown in FIG. 5, in which case the outer channel 340 with the cross-flow fan device is positioned on the back of the housing 210 and directed downwards, or at the front, as shown in FIG. 6, in which case the outer channel 340 with the cross-flow fan device placed at the front of the housing 210 and directed downwards for blowing air through the elements in the housing 210 at absence of requisite speed related wind. In order not to interfere with the maximum permitted height of vehicle 400, it is possible to place the housing 210 on the roof 404 of the driving compartment, inclined with the outlet opening 214 flush with the roof 402 of the cargo department, as shown in FIG. 7a, and with the outer channel 340 directed obliquely downwards against a plow-like shield 410 in order to divide the air outflow laterally into two air flows, which shield is attached to the roof 404 guiding the air flow laterally as shown in FIG. 7b, where the position of the housing 210, not shown, is indicated by dashed lines. Hence, the speed related wind will flow straight through the housing 210 passing by the edge of the cargo department roof 402. With the truck standing still, the fan device in the outer channel 340 will suck air through the housing 210 and blow it out against the shield 410.

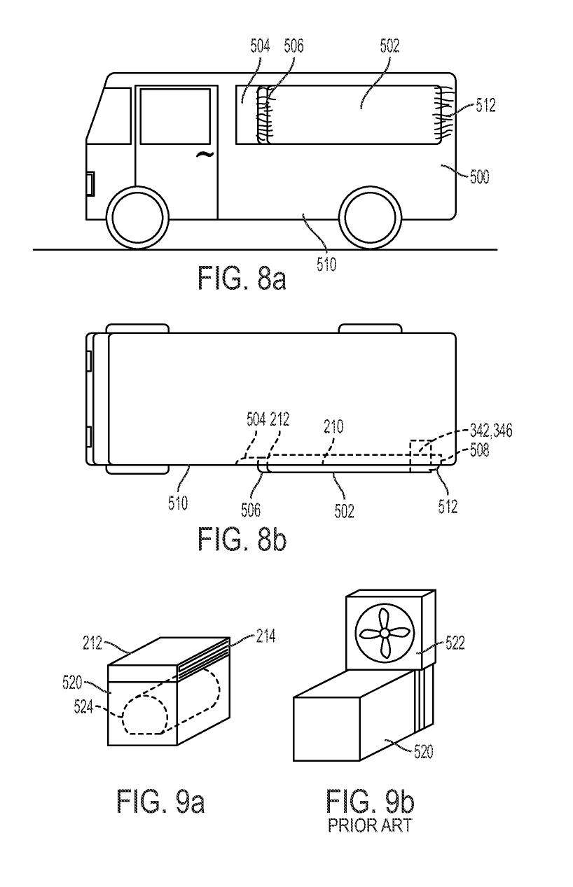

The van 500 shown in FIGS. 8a and 8b has a heat exchanging device according to the invention with the housing 210 in a vertical position inside a slight bulging 502 of the car body 510 on one side of the van. The heat exchanger device is of the kind shown in FIGS. 3a and 3b or FIGS. 4a and 4b with an outer channel 342 or 346 protruding into a compartment in the inner of the van. In front of the inlet opening 212 of the housing 210 the car body is designed with a concavity 504 that exposes the inlet opening 212 that is covered sparsely by a grill 506 permitting free inflow of cooling air. Also at the outlet opening 214 the car body has a concavity 508 and a grill 512 permitting free outflow of cooling air.

As disclosed, the present invention 100 also has an important field of application as a stationary cooler, especially combustion engines. A combustion engine, (not directly shown), with associated equipment is, as indicated in FIG. 9a, in usual manner placed in a standard container 520, which has a plain upper side supporting the housing 210, which contains the heat exchanger device according to the invention. The housing 210 is, in order to achieve a maximum cooling capacity, dimensioned to completely cover the upper side of the container such that the inlet and outlet openings 212, 214 exactly reach the long sides of the container. In this way, an extremely compact unit is presented, which in many respects is superior to the known type of cooler 522, shown in FIG. 9b, which often is used on the same type of container 520. The cooler 522 is of conventional type with an electrically driven propeller in front of a package of heat exchangers in several layers, which gives rise to a large drop of pressure and in spite of a large electric power meets up to difficulties to obtain a similar cooling ability as the device according to the invention, shown in FIG. 9a.

If the devices in FIGS. 9a and 9b are meant for use indoors e.g., in factory premises, it is typically necessary to have these devices provided with a diffuser device and silencing device. The system 100 according to the present invention, shown in FIG. 9a, is preferably provided with such diffuser and silencing devices comprising of a silencing shield 530, 540 going out from the roof 216 of the housing 210 at each inlet opening 212 and outlet opening 214.

In front of the inlet opening 212 there is a fan assembly 350 that can include a fan device 352 of cross-flow type and at the outlet opening 214 the shield 540 is provided with a number of arched rails 542 that are located in parallel with the opening 214 and guide a softly curved change of flow direction of the outflow of cooling air, which by the shield 540 thereafter is directed downwards along the side of the container at a gradually increasing distance from the side guided by an outwardly sloping shield 544. Both shields 530, 540 are provided with horizontal slots 550 with guide rails 552, which together with the sloping shields 544 guide the air flow through the slots 550 at a low air flow velocity and a low drop of pressure against the inlet opening 212 and the fan device 352 as well as from the outlet opening 214 and through the slots 550 and out into the surrounding room. The shields 530 and 540 work in this way together with the sloping shields 544 as effective diffuser devices and silencing devises.

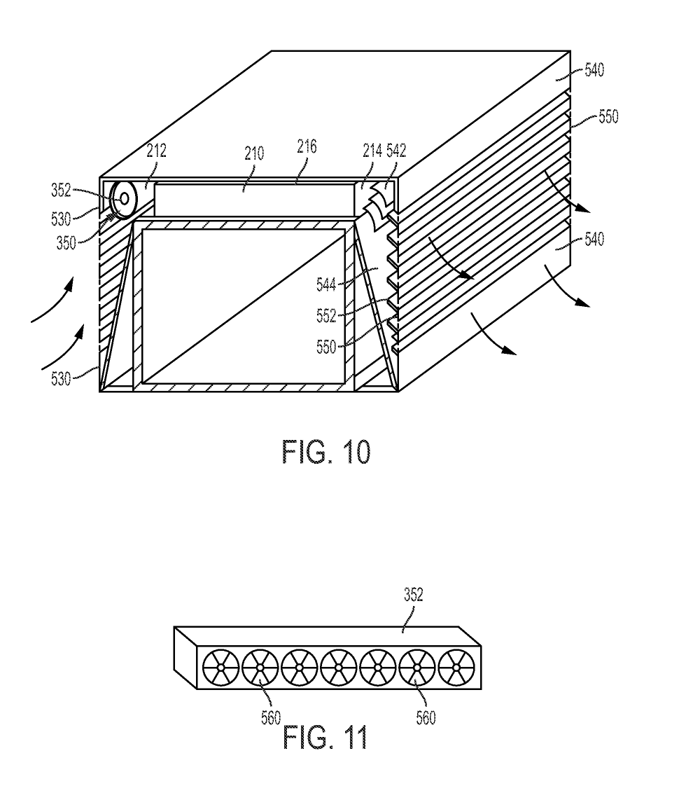

The invention is of course not limited to the shown embodiments since it can be modified in different ways within the scope of the invention defined by the attached claims. This holds especially for details having reference to details for protecting the mobile device from internal dirtying. It is also possible to design a further side of the vehicle, preferably a hood panel or a roof, in such a way that the housing 210 in a profitable way may be attached on or inside the vehicle. Moreover, the diffuser and silencing device shown in FIG. 10 may be manufactured as a unit that can be lowered down over the container and heat exchanger device shown in FIG. 9a and secured to this.

The expression fan device of cross-flow type includes, as previously mentioned, all kinds of fan devices that suck in air laterally and force it out laterally, with or without an angular change of direction with respect to the suck in direction. As an example of an uncomplicated one is referred to FIG. 11, which shows a fan device 352 comprising a row of small propeller fans 560 that directly or via a transmission (not shown) is driven by one or more electric motors, not shown.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. An air-cooled heat exchange system comprising:
a housing having an average length greater than its average height; and
heat exchange media located within the housing;
wherein the housing includes an inlet, and outlet, a bottom, a top, and opposing side walls;
wherein the heat exchange media comprises a V-shaped structure of heat exchange elements mounted vertical between the top and the bottom of the housing, and extending across the width of the housing, from one side of the housing to the other side of the housing, adjacent heat exchange elements connected to one another at an end portion, the plurality of heat exchange elements located at an angle from one another across the width of the housing forming the V-shaped structure; and
wherein the heat exchange elements are rectangular, disc-shaped, and air pervious.

2. The air-cooled heat exchange system of claim 1, wherein when the housing is moving the housing accepts air through the inlet, through the heat exchange media arranged at least partially crosswise to the flow of air through the inlet, and the air exiting the housing through the outlet.

3. The air-cooled heat exchange system of claim 1 further comprising a coolant pump to pump coolant through the heat exchange media.

4. An air-cooled heat exchange system comprising:
a passive cooling system comprising:
a housing having an average length greater than its average height; and
heat exchange media located within the housing;
wherein the housing includes an inlet, and outlet, a bottom, a roof, opposing side walls;
wherein the heat exchange media comprises a plurality of heat exchange elements extending across the width of the housing, from one side of the housing to the other side of the housing, adjacent heat exchange elements connected to one another at an end portion, the plurality of heat exchange elements located at an angle from one another across the width of the housing;
wherein the heat exchange elements are rectangular, disc-shaped, and air pervious; and
wherein when the housing is moving the housing accepts air through the inlet, through the heat exchange media arranged at least partially crosswise to the flow of air through the inlet, and the air exiting the housing through the outlet.

5.-8. (canceled)

9. The air-cooled heat exchange system of claim 4 further comprising an active cooling system in proximity to the outlet of the housing, the active cooling system providing directional control of the air exiting the air-cooled heat exchange system.

10. The air-cooled heat exchange system of claim 9, wherein the active cooling system comprises:
a flow diverter;
a flow aperture; and
and an outer channel;
wherein the flow diverter diverts the flow of air exiting the outlet of the passive cooling system through the flow aperture and into the outer channel.

11. (canceled)

12. The air-cooled heat exchange system of claim 1,
wherein the heat exchange elements comprise channels containing coolant; and
wherein when the housing is moving the housing accepts air through the inlet, through the heat exchange media arranged at least partially crosswise to the flow of air through the inlet, and the air exiting the housing through the outlet.

13. The air-cooled heat exchange system of claim 12, wherein the housing is mounted on or in a vehicle with the inlet exposed to speed-related wind upon movement of the vehicle.

14. The air-cooled heat exchange system of claim 13, wherein an one or both of an inlet channel from the inlet opening and an outlet channel to the outlet is arranged to communicate with an outer channel moveably arranged at a rear of the housing, the outer channel having a width equal to the width of the inlet or the outlet, respectively, and containing a fan assembly.

15. The air-cooled heat exchange system of claim 14, wherein the fan assembly comprises a cross-flow fan for creating a fan air flow upon the absence of a requisite speed-related wind.

16. (canceled)

17. The air-cooled heat exchange system of claim 12, wherein the inlet and outlet of the housing are positioned in proximity to and in parallel with two opposite edges of the sides of the housing, where at least an end of the housing is extended with a silencing shield, which is gently curved around and distal the corresponding edge and down along the side of the housing distal the side for allowing cooling air to pass.

18. The air-cooled heat exchange system of claim 17, wherein the silencing shield is provided with horizontal, air pervious slots with guide rails for guiding the air flow through the slots with diffuser action.

19.-24. (canceled)

25. An air-cooled heat exchanger comprising channels containing a coolant and connected to cooling ducts of an object to be cooled, which exchanger comprises a row of rectangular, disc-shaped, air pervious, heat exchange elements that are connected edge to edge, angled to and fro a specific angle between the heat exchange elements with the channels containing the coolant, wherein the row of heat exchange elements is arranged in a low, wide and long housing with two open ends forming a mainly rectangular inlet opening and outlet opening for a cooling air flow arranged to pass through the row of heat exchanging elements, which extends, partly crosswise the flow direction of the cooling air flow between two low, opposite sides of the housing, attached to the sides and to remaining two opposite sides, a bottom and a roof of the housing, partly in the longitudinal direction of the housing mainly a distance between the inlet and the outlet openings, which distance is essentially longer than the height of the inlet and the outlet openings.

26.-39. (canceled)

40. An air-cooled heat exchange system comprising a passive cooling system, the passive cooling system comprising:
a housing having an average length and an average height such that the average length is greater than the average height, the housing comprising:
an inlet configured to receive air;
an outlet configured to discharge air;
a bottom;
a top; and
two opposing sides; and
heat exchange media located within the housing, the heat exchange media comprising a plurality of heat exchange elements that extends across a width of the housing.

41. The air-cooled heat exchange system of claim 40, wherein the plurality of heat exchange elements are air-pervious and an end portion of one of the plurality of heat exchange elements is connected to an end portion of another of the plurality of heat exchange elements, such that a V-shaped structure is formed, and such that air entering the inlet will be diagonally intercepted by the plurality of heat exchange elements.

42. The air-cooled heat exchange system of claim 40, wherein at least one of the plurality of heat exchange elements comprises an axial rib configured to guide flowing air through the heat exchange elements essentially along a longitudinal direction of the housing to mitigate loss of air pressure in the housing.

43. The air-cooled heat exchange system of claim 40 further comprising a silencing shield, wherein the silencing shield extends at an end of the housing and is gently curved around and distal an edge of the housing and along the corresponding side of the housing.

44. The air-cooled heat exchange system of claim 40 further comprising an active cooling system configured to provide directional control of air exiting the outlet of the housing, the active cooling system comprising:
a flow aperture;
an outer channel; and
a flow diverter configured to divert a flow of air exiting the outlet of the passive air cooling system through the flow aperture and into the outer channel.

45. The air-cooled heat exchange system of claim 40 further comprising:
an outer channel moveably arranged at a rear of the housing, the outer channel comprising a fan; and
a connecting channel configured to provide fluid communication between the housing and the outer channel.

46. The air-cooled heat exchange system of claim 42, wherein the axial rib is a compressed part of the channel.

47. The air-cooled heat exchange system of claim 45, wherein the outer channel is moveable obliquely downwards relative to the bottom of the housing.

48. The air-cooled heat exchange system of claim 45, wherein the outer channel is moveable obliquely upwards relative to the bottom of the housing.
